(19) United States
(12) Patent Application Publication
(10) Pub. No.: US 2019/0089299 A1
(43) Pub. Date: Mar. 21, 2019

(54) PHOTOVOLTAIC ROOF TILE HAVING A LENGTH-ADJUSTABLE CURRENT LINE

(71) Applicant: RheinEnergie AG, Köln (DE)

(72) Inventor: Peter HAKENBERG, Solingen (DE)

(73) Assignee: RheinEnergie AG, Köln (DE)

(21) Appl. No.: 16/082,273

(22) PCT Filed: Mar. 3, 2017
(86) PCT No.: PCT/EP2017/055003

§ 371 Date: Sep. 5, 2018

(30) Foreign Application Priority Data
Mar. 7, 2016 (DE) 10 2016 104 096.7

(51) Int. Cl. H02S 40/44; H02S 20/25; H02S 40/36; E04D 13/00; F16B 5/06; F16B 1/00; E04D 1/12; E04D 1/02

(52) U.S. Cl. CPC H02S 40/44; H02S 20/25; H02S 40/36; E04D 13/00; F16B 2001/0064; F16B 1/00; E04D 1/12; E04D 1/02; F16B 5/0621

(57) ABSTRACT

The invention relates to a photovoltaic roof tile (20) for obtaining electrical energy from solar radiation. The shape of the photovoltaic roof tile according to the invention corresponds substantially to the shape of a conventional roof tile, comprising a top-side photovoltaic module (26) with a first current line (34) and a second current line (36), said photovoltaic module (26) with being arranged on a base tile (22) which is used to fasten the photovoltaic roof tile (20) on the roof, wherein:
the first current line (34) has a first connection element (38) at its free end,
the second current line (36) has a second connection element (40) at its free end,
at least one of the two lines (34, 36) is designed to be length-adjustable,
the two connection elements (38, 40) are connectable to one another,
the two connection elements (38, 40) are arranged in a basic state within the external dimensions of the photovoltaic roof tile (20),
   and wherein, in an assembly state, at least one of the two connection elements (38, 40) can be drawn out beyond the external dimensions of the photovoltaic roof tile (20) and can be connected in a current-conducting manner with a corresponding connection element (38, 40) of an adjacent photovoltaic roof tile (20).

The present invention relates to a photovoltaic roof tile to produce electrical and thermal energy from solar energy, wherein the photovoltaic roof tile essentially has the shape of conventional roof tile-less.

Photovoltaics is also a widespread technique for the utilization of the solar radiation. The solar radiation enters a photovoltaic module with solar cells. Said solar cells convert the energy of the sunlight into electrically usable energy. The conversion von solar energy into electrically usable energy is well known and will not be described in further details.

Utilization of roof surfaces for affixing solar collectors is widespread. Commercially available solar collectors are mostly applied to already completed roofs in addition. Fastening elements are often required to be mounted through the roofing sheet onto the roof supporting structure, wherein fastening is required to be stormproof and is preferably also required to be corrosion-protected. When per-forating the conventional roofing sheet, sealing and subsequent tightness problems inevitably will arise. In Addition, increase of the roof load occurs, often results in necessary reinforcement in the roof trusses. Moreover, such solar collectors negatively interfere with the optical appearance of the roof.

Alternatively, photovoltaic articles are known, which are used instead of the gen-erally used roof tiles, roof tiles or roofing stone articles. Photovoltaic roof tiles, at the top, i.e. facing the sun, include photovoltaic modules or solar cells for the reception and conversion of the solar energy. The above-mentioned disad-vantages of the mounted solar collectors will largely be avoided, but installation of such solar roof tiles is laborious, and is relatively difficult, compared to conventional roof covering with commercially available roof tiles. An essential problem especially is the great installation effort when connecting the individual solar thermal roof tiles. The electrical current is required to be conducted from one photovoltaic roof tile to the next one, for which reason expenditure in assembly work and time is significantly higher than with large-area solar collectors.

For example, such a photovoltaic roof tile and the assembly thereof is described in DE 10 2011 055 904 A1 and in DE 20 2013 002 407U1. Assembly of the roof tiles as described therein is complex and difficult, especially as additional compo-nents are required and modifications to the supporting structure become necessary.

The object of the present invention is to provide a photovoltaic roof tile, the production, assembly and maintenance of which is as simple and inexpensive as possible. In this context, it is essential for the mounting procedure to differ as little as possible from a roof covering procedure with usual roof tiles.

The object will be solved by a photovoltaic roof tile having the features of the claim 1 as well as the independent Process Claim.

Thus, a photovoltaic roof tile according to the invention comprises a photovoltaic module arranged on the top side of a base tile, which is connected to a first current line and a second current line. The base tile is for fixing the photovoltaic roof tile on a roof.

The photovoltaic roof tile preferably is built up in a sandwich-type manner, wherein the photovoltaic module is arranged between the base tile and a transparent cover.

According to the invention, the base tile may be fabricated of metal, and may especially be produced by the process of deep drawing.

A circumferential frame element arranged between the base tile and the photovoltaic module or the covering element, respectively, is, on the one hand, for fixing the individual elements to each other, and on the other hand, for tightness of the photovoltaic roof tile.

The shape of the photovoltaic roof tile according to the invention essentially corresponds to the shape of a conventional roof tile, so that the appearance of a roof or a house, respectively, will hardly be changed by the use of the solar thermal roof tile. Herein, the meaning roof tile is to be understood as being syn-onymous to roof covering elements such as roof tiles, roofing stones or roofing shingles, and is not meant to limit the invention to roof tiles.

The first current line, at its free end, has a first connecting element, and the second power supply, at its free end, has a second connecting element, which are connectable to each other in fluid-medium communication.

What is essential is that one of the lines are formed as having length variation, and, in a first initial state, both connecting elements may be arranged within the external dimensions of the photovoltaic roof tile. In the assembly state, the connecting element may be expanded due to its length-changeable line so that it projects beyond the external dimensions of the photovoltaic roof tile. In this context, the meaning external dimensions or overall dimensions relates to the overall dimensions of the photovoltaic roof tile in planar or horizontal extension, respectively, which, in a common rectangular photovoltaic roof tile, are determined by the two longitudinal sides and the two transverse sides. In this context, the meanings horizontal and vertical relate to a photovoltaic roof tile abutting against a horizontal plane, so that the main extension thereof is in the horizontal plane.

This means that the photovoltaic roof tile according to the invention, in its initial state, has the same dimensions as a commercially available roof tile without photovoltaic module. In the assembly state, however, the second connecting element may be expanded beyond the external dimensions of the photovoltaic roof tile and may be connected to a first connecting element of an adjacent photovoltaic roof tile. Both of the connected photovoltaic roof tiles may subsequently be moved towards each other, wherein the second current line contracts again, until the two photovoltaic roof tiles, in some areas, are arranged one over the other such that the two connecting elements are arranged below the upper photovoltaic roof tile, i.e. they are arranged as being no more visible.

Basically, according to the invention, the first current line and the second current line or even both power lines may be formed as being changeable in length, in an especially advantageous embodiment, according to the invention, only the second current line is formed as being changeable in length. In the following, the invention will therefore be exemplified for that embodiment, but which is only one of the various possibilities.

The second connecting element connected with the current line is preferably guided in a longitudinal groove extending in an extension direction in the base tile. On the other hand, the first current line and and the first connecting element are fixedly arranged within the external dimensions of the photovoltaic roof tile.

The first current line changeable in length significantly facilitates assembly onto the roof, as the distance deviations between adjacent photovoltaic roof tiles during roofing may quickly and simply be compensated. The variable overlapping of the roof tiles results from different roof batten clearances, which in turn arise due to integer number of roof tiles, when varying roof lengths (from the gutter board to the crest) are required to be realized.

The meaning of first current line changeable in length is to be understood such that said first current line varies in its length in relation to the extension direction of the second connecting element. In an especially preferred embodiment, the second current line may hence be formed as a so called trumpet tube, where two tube portions of different diameter that are sealed against each other may slide into each other. The tube portions itself may be formed as being electrically conductive, however, arrangement of a cable within the tube portions, which in turn have an insulating effect, is also possible. According to the invention, a second current line may be used, the absolute length of which remains constant, but enables increase in length in extension direction due to the change in geometric set-up. This, for example, applies to a helically wound elastic current line or cable, respectively, which, according to the invention, may also be used. Finally, operation of the invention is essential, in that the second current line allows for the second connecting elements to be pulled out.

According to the invention, the electrical connection of the connecting elements is done by contact surfaces, which are arranged at the respective connecting elements. Said connecting elements, in the assembled state of the connecting elements, contact each other so that the electrical power may be conducted. Alternatively, contact surfaces may as well be arranged at another location of the photovoltaic roof tile, i.e. it may be provided independently of the connecting elements.

In an especially advantageous embodiment, the two connecting elements are formed as a snap-in connection or as an engaging connection. For example, the first connecting element may comprise an accommodation opening, into which the second connecting element is insertable and is releasably maintained in a form-fitting manner. Form-fitting, in this context, may be effected by undercut-ting in the accommodation opening, at which undercut a retaining edge of the second connecting element abuts.

To effect safe but still releasable connection, elastic engaging means may be provided, which engage into the respective retaining region. In a particularly easy embodiment, the second connecting element may comprise openings or recesses, into which elastic and/or spring-loaded pins of the first connecting element engage. During connection procedure, the pins are initially displaced by the second connecting element until they may return into the respective recesses or openings.

The two connecting elements are fixedly connected in the engaged state, wherein the connection especially is effected by at least one, preferably two spring-loaded pins. In this context, the engaging openings and the free end of the pin are dimensioned such that the pin is only partially and not completely inserted into the opening. For this purpose, the pin, at its free end, may be formed conically. It will thereby be achieved that the connection in vertical direction, i.e. transversally to the insertion direction of the pin, is locked, on the other hand, the spring force acting in longitudinal direction of the pin compressed the two connecting elements towards each other, thereby assuring a safe and permanent connection. It is to be understood that other engaging connections may also be utilized, which ensure sufficiently reliable connection of the two connecting elements.

Advantageously, the connection of the connecting elements may be released (by wax of an appropriately formed tool) by compressing the pins opposite to the spring force, and pulling out the second connecting element of the first connecting element. For this purpose, for example, an appropriate tool may be used, which disengages the pin and the engaging opening.

In order to additionally facilitate assembly, the second connecting element is preferably guided. The guide may for example be effected by a longitudinal groove in the base tile, into which the retention region of the second connecting element protrudes and is retained. It is thereby assured that the second connecting element may exclusively be displaced along the longitudinal groove and especially may not get distorted.

In an especially advantageous embodiment, the accommodation opening is formed within the first connecting element in a T-shaped manner and is formed as being open towards the top. Accordingly, the second connection element is also formed in a T-shaped manner and is insertable into the accommodation opening from the top. By way of the T-shape, locking in the essentially horizontal pulling direction is automatically created. For the connection in the vertical direction may not be released, spring-loaded pins, which are arranged in the first connection element, engage into openings of the second connecting element, which are preferably arranged in the two short regions of the T-shape that are formed transversally to the longitudinal extension of the second power line.

Preferably, the accommodation and the snap-in element, at least in certain areas, may be formed of electrically conductive material, and may form the contact surfaces for conducting electrical power. Especially, the pins per se and an edge of the accommodation, which contact the pins in the assembled state, may form the contact surfaces.

An essential advantage of the described connection configuration with the connecting elements according to the invention is the degrees of freedom of the connection in translational and rotational direction. This, for example, may additionally be assisted by a rubber bearing for the two connecting elements.

The photovoltaic roof tiles according to the invention may be installed fast and easy onto a roof supporting structure. They may be transferred, with the second connection element being retreated, onto the roof and may be processed thereon, like commercially available roof tiles. For this purpose, it is only required for the second connection element to be pulled out of the photovoltaic roof tile and to couple it, via the engaging connection, to an adjacent first connection element.

The photovoltaic roof tiles adjacent to the so called gutter board of the roof preferably comprise connecting lines instead of the first current lines. The connecting lines may also be formed as being changeable in length, and, with their free ends, may be connected to a main power line, which leads to an end user or energy storage.

Installation of the main power line within a downspout that is arranged within a house has been proven to be especially advantageous. It is for discharge of rain water, but may also accommodate the main power line in the interior. In an especially preferred embodiment, said connecting lines may be separated by a separating wall from a rainwater-conducting region of the downspout. Thus, for this purpose, the downspout is divided into two compartments.

Moreover, it has been proven to be of advantage, if a pilot current may be fed via the connecting elements, besides the electrical line for the recovered energy. Said pilot current is especially required for so called CAN busses.

The photovoltaic roof tile of the invention is especially suitable for use with a wind suction protection which is also new and advantageous. In some geo-graphic regions, wind suction protections have already become mandatory. Pre-vention of unroofing the roof due to storm (wind suction) is therewith intended. This will typically be realized by attaching a wire or a clamp to the roof tile, which anchors the roof tile in the roof batten. The anchoring procedure is comparatively time-consuming, and depending on the on-site situation, sometimes requiring more time than the roofing procedure with the roof tile. Moreover, it is extremely difficult to replace such a roof tile (e.g. if it is damaged) in the roof network structure (completely tiled roof).

The wind suction protection of the invention diminishes those problems. A snap-in lug is activated when overlaying the roof tile onto the roof tile, it will be urged behind the roof tile by spring force and thus clasping behind. For disengaging this connection mechanism, if repair is required, a return mechanism having a draw bar including draw bar eye is advantageously provided at the bottom side of the roof tile in the front region. When slightly lifting the roof tile in the front, it is possible for a hook to engage into the draw bar eye and drawing the snap-in lug back to its engaging position. This engaging position is the delivery default state and will be changed during roofing procedure, i.e. when the roof tile will be laid onto the roof batten in proper position.

Replacing a conventional roof tile has always been relatively difficult (even without additional wind suction protection). This is due to the fact that the roof tile to be replaced is required to be removed from the roof batten, even though two adjacent roof tiles (overlaying on top and usually on the left hand thereof) are loaded thereon. However, if another two connections are required to be released, this is almost impossible, unless additional auxiliary tool will be used. The wind suction protection with snap-in lug solves the problem by providing an additional mechanism for lifting the roof tile. For this, a draw bar including draw bar eye is drawn under the roof tile at the front end, which in turn actuates a draw key between the roof tile and the roof batten to lift the roof tile.

Another improvement or alternative of the invention, respectively, resides in the actuation of another draw bar including draw bar eye at the front end of the roof tile to release the connection between the roof tiles by actuating an ejector (to eject a pater out of the mater). In this way, a lifting tool becomes unnecessary.

Said three draw bar eyes are all located below the roof tile at the lower end. The draw bar eyes are vertically oriented and would “spring-off” from the bottom side of the roof tile as soon the latter will be lifted in the front. An eye is then advantageously arranged slightly offset from the center of the roof tile (center of the front side) and releases the connection. This position is advantageous as the connection is arranged as being exactly located in the center of the roof tile. Some centimeters offset thereof, for example about 3 cm to the left, according to the invention, the draw bar eye for the snap-in lug of the wind suction protection is positioned. This position is advantageous as the typical wind suction protection is always provided at the left roof tile side. On the other side, some centimeters to the right of the center, preferably also 3 cm to the right of the center, the draw bar eye for the draw key is preferably arranged, which is for lifting the roof tile.

According to the invention, combination of the draw bar eyes for the snap-in lug and the roof tile lifter is conceivable. The sequence would be such that in the first half of the draw path, the snap-in trap will be retracted, and in the second half of the drawing distance, the draw key for lifting the tile will be actuated. It is preferred that a spring element is provided, via which the bias applied to the snap-in lug will be maintained, for said snap-in lug does not snap back when lifting.

The invention will be explained in detail by way of the following figures, said figures showing a preferred working example of the invention, which, however, is not intended to limit the invention to the features shown, wherein

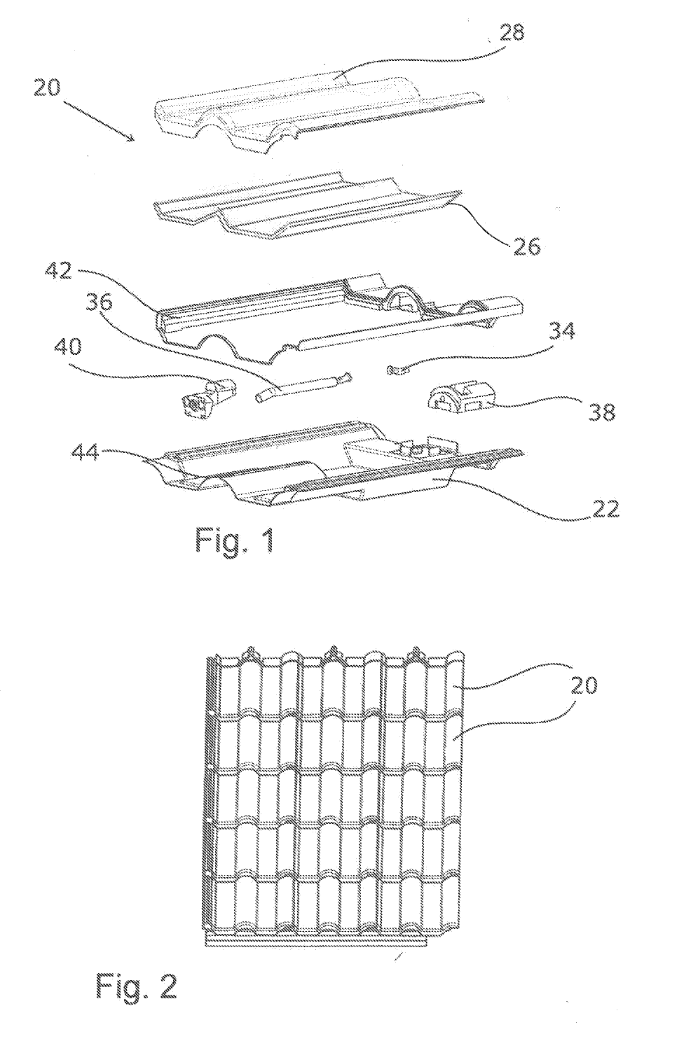

FIG. 1 shows a photovoltaic roof tile according to the invention in explosive representation,

FIG. 2 shows a portion of a roof, which is covered with photovoltaic roof tiles according to the invention;

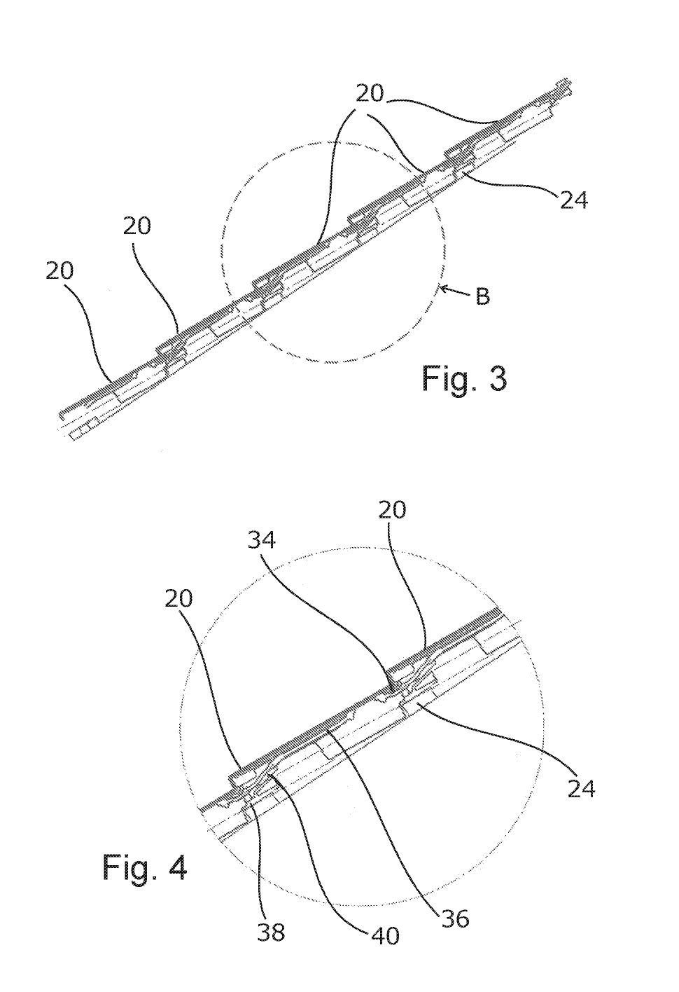

FIG. 3 shows a cross section of the row of installed photovoltaic roof tiles;

FIG. 4 shows an enlarged sectional view of FIG. 3;

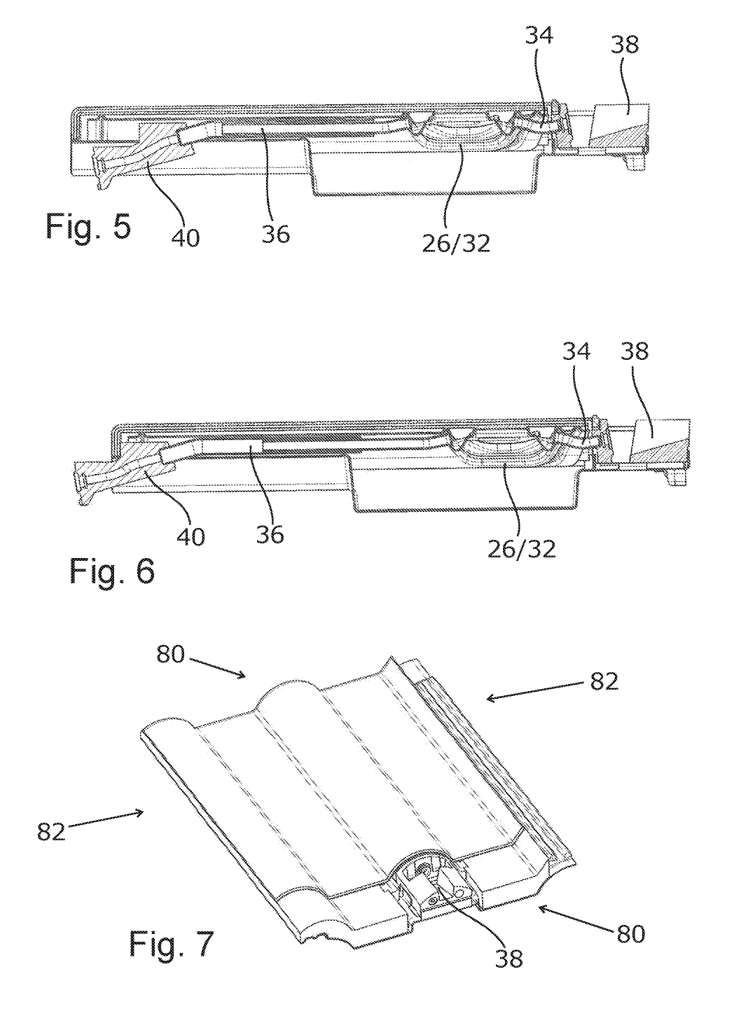

FIG. 5 shows a longitudinal section of the photovoltaic roof tile according to the invention;

FIG. 6 shows a longitudinal section of the photovoltaic roof tile according to the invention, with the connection element being extended;

FIG. 7 shows a top view of the photovoltaic roof tile according to the invention;

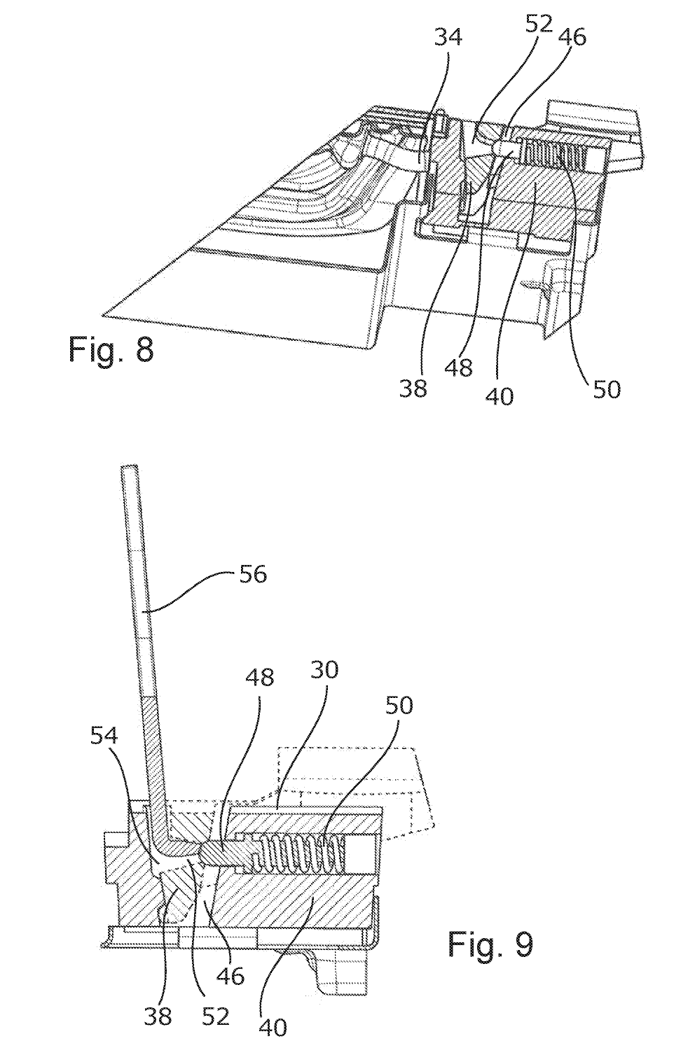

FIG. 8 shows two connecting elements of two photovoltaic roof tiles in the assembled state;

FIG. 9 shows a releasing operation of the connection of FIG. 8 with the help of a tool;

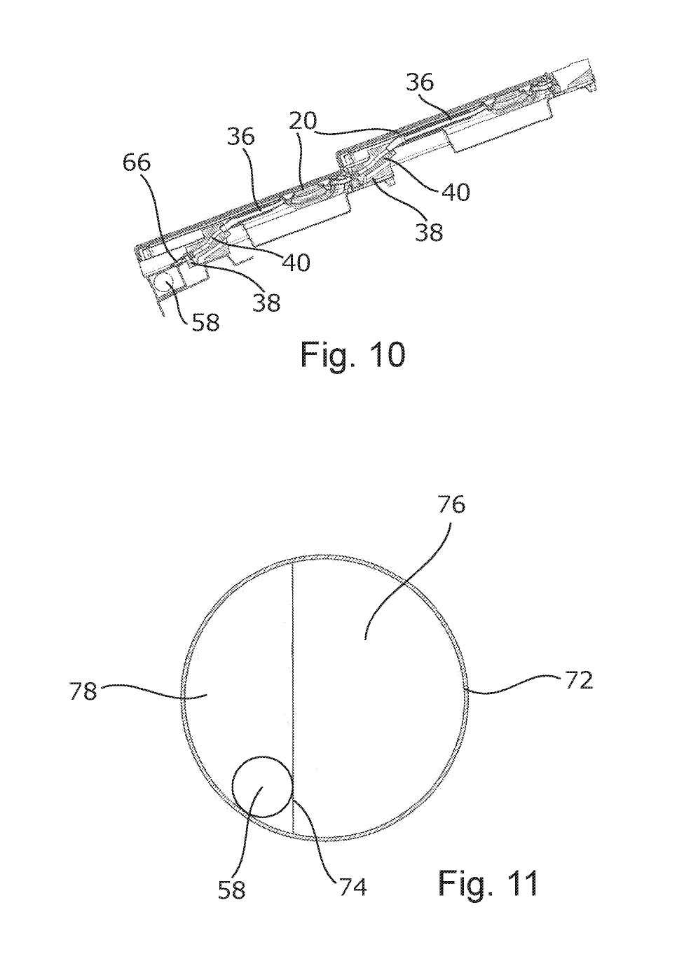

FIG. 10 shows coupling of the photovoltaic roof tiles to a main power line;

FIG. 11 shows a cross section of a downspout including a main power line.

FIG. 1 shows an explosion representation of a preferred embodiment of a photovoltaic roof tile 20 according to the invention. Basically, the photovoltaic roof tile 20 is configured in sandwich-type construction mode. Starting from of a base tile 22, which forms a bottom side of a photovoltaic roof tile 20 and is laid on top of a roof supporting structure 24 (also cf. FIG. 3), it is followed by a photovoltaic module 26 and preferably a transparent or translucent cover 28.

The cover 28 completely covers the photovoltaic module element 26. The photovoltaic module element 26 is connected to a first current line 34 and a second current line 36. The first current line 34 is followed by a first connecting element 38 and the second current line is followed by a second connecting element 40. The two connecting elements 38, 40 each may be connected to a corresponding connecting element 38, 40 of an adjacent photovoltaic roof tile 20.

A frame 42 is furthermore shown, approximately having the dimensions of the base tile 22 and serving for the accommodation of the photovoltaic module 26. Moreover, in the working example shown, the cover 28 is supported on the frame 42 and is connected thereto.

In FIG. 1, it is not to be seen that the second connection element 40 is guided in a longitudinal groove 44 of the base tile 22. This significantly facilitates assembly of the photovoltaic roof tile 20 by way of specifically pulling out the second connecting element 40. The longitudinal groove 44 furthermore avoids dis-tortion of the second connecting element 40.

Finally, it is essential for the second poser supply line 36, which is arranged between the lower photovoltaic module element 32 and the second connection element 40 to be changeable in length. In the working example shown, a trumpet pipe is provided, which is formed of two pipe portions which are slidable into each other and having different diameters. In the trumpet tube, an electrical cable, preferably a helical cable is passed through.

From the FIGS. 2 to 4, the installation according to the invention of photovoltaic roof tiles 20 on a roof or a roof supporting structure 24, respectively, becomes clear. FIG. 2 shows a top view of a region of a roof FIG. 3 shows a longitudinal section across a row of photovoltaic roof tiles 20, and FIG. 4 shows an enlarged view of the region B from FIG. 3.

It is to be seen that the photovoltaic roof tiles 20, which are connected to each other, overlap in some areas, similar to conventional roofing with conventional roof tiles. They abut against the roof supporting structure 24 with their bottom side, i.e. the bottom side of the base tile 22. Especially in FIG. 4 it is shown that respective adjacent photovoltaic roof tiles 20 are arranged one over the other, and are connected to each other via the connecting elements 38, 40. Thus, the electrical energy generated will be transferred to the next photovoltaic roof tile 20 from a photovoltaic roof tile 20 through the first current line 34, the two connecting elements 38, 40, the photovoltaic module 26 and the second current line 36.

FIG. 5 illustrates the design of the photovoltaic roof tile 20 according to the invention. In this embodiment variant, which is also shown in FIGS. 6 and 10, the photovoltaic module 26 slightly differs from the embodiment variant according to FIG. 1, in relation to the external dimensions. Particularly, a partial region slightly higher in cross section is provided, where, for example, control technology may be accommodated.

It is to be seen that the first connecting element 38 is followed by the first current line 34. The second power line 36 is also connected to the photovoltaic module 26 and leads to the connecting element 40. In this initial state, the connecting elements 38, 40 do not protrude beyond the external dimensions of the photovoltaic roof tile 20.

For installation of the photovoltaic roof tiles 20 it is furthermore of advantage that the photovoltaic module 26 and the cover 28 do not entirely cover the first connection element 38 so that it easily remains accessible during tiling the roof. The first connection element 38 will finally be first covered by the installed adjacent photovoltaic roof tile 20, thereby being no longer visible in the installed state.

FIG. 6 shows a longitudinal section of a photovoltaic roof tile 20 having extended second connection element 40. As already set forth, the second current line 36 in the trumpet tube is formed as being changeable in length, so that the second connection element 40 may be pulled out beyond the overall dimensions of the photovoltaic roof tile 20. It then protrudes opposite of the respective edge or side of the photovoltaic roof tile 20 and may smoothly be connected to an adjacent first connection element 38.

FIG. 7 explains, by way of a top view representation of the photovoltaic roof tile 20, that in the initial state, there are no elements protruding over the overall dimensions of the photovoltaic roof tile 20. The overall dimensions are specified by the two transverse sides 80 and the two longitudinal sides 82. It may as well be seen that an accommodation opening 46 of the first connecting element 38, in the initial state, is not covered by the photovoltaic module 26 or the cover 28, but is open towards the top, i.e. towards the direction facing away from the base tile 22. The accommodation opening 46 essentially is formed as being T-shaped.

The FIGS. 8 and 9 exemplify the advantageous connection of two photovoltaic roof tiles 20 via the two connecting elements 38, 40. The two connecting elements 38, 40 are shown in longitudinal section view, wherein the second current line 36 is not being drawn. What may be seen is the accommodation opening 46 (or accommodating recess), into which the second connecting element 40 is insertable. The T-shape causes the connection to be secured in essentially horizontal direction, i.e. in the extension direction of the second connecting element 40, and the two connecting elements 38, 40 may not be disengaged from each other.

In addition, spring-loaded pins 48 are to be seen as snap-in elements. In the working example shown, two pins 48 are provided, each one of which being oriented parallel adjacent to the second current line 6.

A spring element 50 urges the respective pin 48 towards an accommodation 52, which is arranged in the second connecting element 40. A snap-in or click connection will thereby result, which also secures essentially in the vertical direction, i.e. transversally to the extension direction of the second connecting element 40.

In the exemplary embodiment shown, an edge of the accommodation 52 and the outer surface of the pins 48 serve as contact surfaces for the electrical connection of the two connecting elements 38, 40. The pins 48 each have a conically shaped free end, the diameter of which is dimensioned such that the pins 48 will not be entirely inserted into the respective accommodation 52. In this way, it will be achieved that the spring force of the spring element 50 acts towards an appropriate edge of the respective accommodation 52. The pressure of the spring element 50 causes the electrical connection between the two connecting elements 38, 40 to be secured.

FIG. 9 furthermore shows that, in the assembled state of the two connecting elements 38, 40, an access opening 54 for a tool 56 results. Into this access opening 54, an angular-shaped tool 56 is insertable, by which tool the two pins 48 may be pushed back against the spring force of the spring element 50, thus allowing release of the two connecting elements 38, 40 from each other.

FIG. 10 illustrates the connection of the photovoltaic roof tiles 20 having a main power line 58. The main power line 58 may sectionally be arranged in the region of a gutter board of the roof. A row of photovoltaic roof tiles 20, which are arranged in the edge region of an area of photovoltaic roof tiles 20 according to the invention, preferably the lower row of a roof, is coupled to the main power line 58 via a connecting power line 66.

FIG. 11 illustrates an advantageous installation of the main power line 58, in some places within a downspout 72. In this case, the downspout 72 preferably is divided into two compartments by a separating wall 74, wherein a first compartment 76 is for discharging rain water, a second compartment 78 is for accommodating the main power line 58. This mode of installation, on the one hand, is cost-effective and quickly feasible, on the other hand the external appearance of the house will not negatively be affected.

The invention is not limited to the working examples shown and represented, but also includes other possible embodiments. Especially, instead of the second power line 36, the first power line 34 or even both lines 34, 36 may be formed as being changeable in length. Instead of the base tile 22, it is also conceivable that the photovoltaic module 26 is for mounting directly to the roof structure 24, i.e. the base tile 22 may thus be omitted.

1. A photovoltaic roof tile (20) for the production of thermal energy from solar radiation, the shape of which essentially corresponds to the shape of a conventional roof tile, comprising a photovoltaic module (26), which is connected to a first current line (34) and a second current line (36) and is arranged on a base tile (22), which is for mounting the solar thermal roof tile (20) on the roof, wherein
the first current line (34), at its free end, comprises a first connection element (38),
the second current line (36), at its free end, comprises a second connecting element (40),
at least one of the two power lines (34, 36) is formed as being changeable in length,
in an initial state, both connecting elements (38, 40) are arranged within external dimensions of the photovoltaic roof tile (20),
in an assembly state, at least one of the two connection elements (38, 40) may be pulled out beyond the external dimensions of the photovoltaic roof tile (20), so that it is connectable to a corresponding connection element (38, 40) of an adjacent photovoltaic roof tile (20).

2. The photovoltaic roof tile (20) according to claim 1, characterized in that the two connecting elements (38, 40) each comprises an electrical contact surface, which contact surface each is connected in an electrically conductive manner to an associated power line (34, 36), wherein the contact surfaces, in the assembled state of two connecting elements (38, 40), contact each other, thus causing electrical connection to be provided.

3. The photovoltaic roof tile (20) according to claim 1, characterized in that the second current line (36) is formed as being changeable in length.

4. The photovoltaic roof tile (20) according to claim 3, characterized in that the first connection element (38) and the second current line (34) are arranged locally fixed within the photovoltaic roof tile (20).

5. The photovoltaic roof tile (20) according to claim 1, characterized in that the two connecting elements (38, 40) are formed such that they form a snap-in connection.

6. The photovoltaic roof tile (20) according to claim 1, characterized in that the first connecting element (38) comprises an accommodation opening (46) which is open towards the top and t-shaped in horizontal plane for accommodating the second connecting element (40) which is also formed as being T-shaped.

7. The photovoltaic roof tile (20) according to claim 6, characterized in that the second connecting element (40) comprises at least one accommodation (52), into which a snap-in element is engageable, the snap-in element being arranged in the first connecting element (38).

8. The photovoltaic roof tile (20) according to claim 6, characterized in that the snap-in element is configured as a spring-loaded pin (48), wherein the accommodation (52) and the pin (48) are arranged essentially in horizontal direction.

9. The photovoltaic roof tile (20) according to 8, characterized in that the accommodation (52) and the snap-in element are formed of an electrically conductive material, at least in certain area, and forming the electrical conductive contact surfaces.

10. The solar thermal roof tile (20) according to claim 8, characterized in that free end of the pin (48) is formed in a conically tapering manner such that said pin contacts an edge that limits the accommodation (52), an outer surface of the pin (48) and the edge forming the contact surfaces.

11. The solar thermal roof tile (20) according to claim 8, characterized in that the two connecting elements (38, 40), in the assembled state of the two connecting elements (38, 40), form an access opening (54) for a tool (56), by means of which the pin (48) may be urged backwards, allowing release of the two connecting elements (38, 40) from each other.

12. A photovoltaic system for the production of thermal energy from solar radiation, comprising photovoltaic roof tiles (20) according to claim 1, which are connected to a utilization facility via a main power line (58).

13. The photovoltaic system according to claim 12, characterized in that the cold water line (58), the hot water line (60) and the main power line (58) are partially arranged in a downspout (72).
